(19) United States
(12) Patent Application Publication
(10) Pub. No.: US 2016/0319892 A1
(43) Pub. Date: Nov. 3, 2016

(54) Pre-split Composite Brake Drum with Steel Bands

(71) Applicant: Shangdong Haoxin Machinery Co., Ltd., Weifang (CN)

(72) Inventors: Guangming PU, Weifang (CN); Jixian LV, Weifang (CN)

(73) Assignee: Shangdong Haoxin Machinery Co., Ltd., Weifang (CN)

(21) Appl. No.: 14/988,752

(22) Filed: Jan. 6, 2016

Related U.S. Application Data
(63) Continuation-in-part of application No. PCT/CN2015/078529, filed on May 8, 2015.

(30) Foreign Application Priority Data
Apr. 29, 2015 (CN) 201520270309.2

(51) Int. Cl. F16D 65/10

(52) U.S. Cl. CPC F16D 65/10

(57) ABSTRACT

The present invention discloses a brake drum, which relates to a drum-typed brake for vehicles. The brake drum comprises: a brake drum body, which comprises a mounting portion for connecting a wheel, a braking portion for engagement with a brake shoe, and a transitional connecting portion disposed between the mounting portion and the braking portion; one, two or more than two cracks disposed on the wall of the braking portion, wherein each crack begins at the end of the braking portion and ends at the transitional connecting portion; and a hoop device tightly mounted to the whole outer peripheral surface of the braking portion. Heat expansion stress and tension stress of the brake drum body are released into the cracks when braking, which reduces the probability that the brake drum body develops from longitudinal micro cracks to random multiple cracks and finally develops into fractures, which improves safety and extends service life. The disposition of the hoop device improves the tensile resistance strength and fatigue resistance of the brake drum body. The hoop device also applies a clasp force to the brake drum body, which avoids the danger of burst and flying out of the brake drum body and greatly improves service life and use safety.

### STATEMENT

The present invention claims the priority of the following two applications Chinese utility model patent application titled “Brake Drum”, of which the application date is Apr. 29, 2015, and the application number is 201520270309.2.

Chinese invention patent application titled “Pre-splitting-typed Brake Drum”, of which the application date is Jan. 13, 2015 and the application number is 201510016496.6.

### TECHNICAL FIELD

The present invention relates to the technical field of drum-typed brake for using in vehicles, especially relates to a brake drum.

### BACKGROUND ART

Drum-typed brake is one of the important systems of vehicles and is a brake system applied in vehicles at the earliest time. Its greatest advantage lies in that it is simple in structure and economical in cost, but it can provide a potent braking force, and it can also be easily installed and maintained.

At present, integrally cast drum-typed brake is widely used in heavy trucks. The integrally cast drum-typed brake comprises a brake drum and a brake shoe. The brake shoe is mounted in the brake drum and can contact with the inner side face of the brake drum. The brake drum is mounted on the wheels and rotates with the wheels during moving of an automobile. When braking, the brake piston will push the brake shoe outwardly to make it press against the inner side face of the brake drum, and the frictional resistance between the shoe and the brake drum slows down or stops the moving automobile, so as to ensure driving safety.

When a vehicle is heavily loaded or moving in a high speed, especially when going down a long or steep slope, a large braking force and continuous multiple times of braking are required to ensure the controllable condition of the vehicle, which causes the temperature of the inner wall of the brake drum rise rapidly and the temperature difference between the interior and exterior of the brake drum increase, resulting in a sharp decreasing of the high temperature mechanical properties of the materials making up the brake drum and also a decrease of fatigue strength of the materials. The traditional material of brake drum is gray cast iron which has advantages of large friction coefficient and excellent heat transfer property, while its strength is low and brittleness is large. In order to reduce the negative effect brought by these features, the wall of the brake drum must be made very thick, so as to ensure a higher structural strength of the brake drum. A thick wall, however, will cause the temperature difference between the interior and exterior of the brake drum body to increase during braking, which in turn produces a large temperature difference stress and causes the high temperature mechanical properties of materials to deteriorate, and furthermore, because the resulting expansion stress cannot be eliminated in time, the brake drum body develops longitudinal micro cracks, which gradually develops into a lot of cracks and finally causes fracture. Thus, the service life of the integrally cast drum-typed brake is short.

A thickened brake drum wall will also increase the weight of the whole vehicle, increase gasoline consumption and manufacturing cost, which is not good for energy conservation and emission reduction.

Moreover, it is well known that brake drums will be in a high temperature state after braking, if it contacts with water, the drum body may be heat-cracked and blown out due to the chilling, and more seriously, the brake drum can burst and fly out causing safety accidents, and therefore, the safety of use is poor.

Various attempts have been made in improving the conventional drum brakes for increased strength, heat dissipation, and durability, and lightened weight. For example, composite brake drums were made that contain a steel shell with gray cast iron centrifugally cast into the steel shell. The steel shell provides the structural strength to prevent cracking, and the gray iron liner provides the wear surface for the brake lining and heat absorption from the friction of the brake lining. The composite brake drum is conventionally fortified by a “squealer band”, positioned near the inboard, open end of the brake drum, to provide rigidity and to prevent cracks that may start at the open end. An improvement of this configuration, U.S. Pat. Publication No. US2009/0065313, locates the squealer band midway along the width of the brake drum main body, to provide efficient use of the brake structure to receive the force from the brake shoe, and to absorb the most heat, because the mid-point of the brake drum is the portion on which the most force is exerted from the brake shoe.

These prior art brake drums still suffer from the above discussed drawbacks. For example, the steel shell is a poor heat conductor. Attempts were made to facilitate heat dissipation by adding axial fins or rigs to the squealer band, see e.g. US 2008/0308364, but the results remain unsatisfactory.

### CONTENTS OF THE INVENTION

The technical problem to be solved in the present invention is to provide a brake drum which can eliminate heat expansion stress or tension stress, reduce the happening of cracking phenomenon, thereby having a high safety and a long service life.

In order to solve said technical problem, the technical solution of the present invention is: a brake drum, comprising: a brake drum body having a cylindrical shape, which sequentially includes in its axial direction a mounting portion for connecting with a wheel, a braking portion for fitting with a brake shoe, and an opening end of the brake drum; a transitional connecting portion is disposed between the mounting portion and the braking portion; wherein, one, two or more than two axial cracks are disposed in the wall of the braking portion, each crack starting from the vicinity of the end of the braking portion and ending at the transitional connecting portion; and a hoop device is tightly mounted to the entire outer peripheral surface of the braking portion.

Wherein, through-holes, the number of which is equal and corresponding to the number of the cracks, are disposed on the transitional connecting portion, and each crack ends at one through-hole.

Wherein, the cracks are linear cracks, zigzag cracks or wavy cracks.

As an improvement, the hoop device is constructed from steel materials. Via the clasp force of the hoop device, on the premise that the thickness of the brake drum is reduced, the structural strength of the brake drum body is maintained or even improved, while the heat dissipation property of the brake drum is hardly affected.

As an improvement, the structure of a hoop device is: comprising two or more than two hoop ferrules. Said hoop ferrules have a radial height along the diameter direction of the brake drum and an axial height along the axial direction of the brake drum. According to one technical solution of the present invention, whatever cross section shapes the hoop ferrule has, its radial height is appropriately greater than its axial height so as to maximize the axial strength, and meanwhile reduce the contact area with the brake drum body made of gray cast iron to avoid hindering heat dissipation.

As described hereinafter, the cross section shape of the hoop ferrule may be rectangular, U-shaped, L-shaped, T-shaped, H-shaped, tooth-shaped structure, or having a heat dissipation groove. Selection of the shape is to reduce the thickness and weight of the hoop ferrule while increase its heat dissipation surface area as possible, on the premise of ensuring the structural strength of the brake drum body.

According to one technical solution of the present invention, the cross section area of the hoop ferrule in the middle position of the brake drum can be greater than the cross section area of the hoop ferrules on two sides. Because When braking, the force imposed on the braking portion will incrementally decrease from the middle position to the two sides, the arrangement of the size of the hoop ferrule incrementally decreasing from the middle position to the two sides can ensure the safety of the brake drum body while reduce the weight and cost as far as possible. On the basis of not affecting the above principles, the height and shape of the hoop ferrule can be changed according to other technical requirements. For instance, the height of the hoop ferrule which is adjacent to the mounting portion where the brake drum body is connected to a wheel may be lower so as to avoid contacting with the air valve of the wheel.

According to one technical solution of the present invention, the hoop device is a hollowed-out hoop case. The unibody structure of the hoop case is easy for assembling, and can increase the assembling efficiency of the hoop case and the brake drum body.

According to one technical solution of the present invention, a plurality of hoop ferrule mounting grooves are disposed on the outer peripheral surface of the braking portion, and each hoop ferrule is restrainedly mounted in one hoop ferrule mounting groove.

Wherein, the cross section shape of the hoop ferrule is an unequal height U-shaped structure; the outer peripheral surface of the braking portion is disposed with one hoop ferrule mounting groove, and all the hoop ferrules abut against each other sequentially and are restrainedly mounted in the hoop ferrule mounting groove.

Wherein, the radial height of the hoop ferrule decreases incrementally from the middle position to the two sides.

As another improvement, the structure of the hoop device is: comprising a plurality of first hoop ferrules arranged and disposed in the axial direction, and a second hoop ferrule disposed away from the transitional connecting portion and between two adjacent first hoop ferrules, and all the first and second hoop ferrules abut against each other; the width of the first hoop ferrule is greater than that of the second hoop ferrule, and the external diameter of the first hoop ferrule is less than that of the second hoop ferrule.

Wherein, the cross section shape of the first hoop ferrule is U-shaped or L-shaped or square; the end of the second hoop ferrule which is away from the braking portion is square or semicircular or U-shaped.

As still another improvement, the structure of the hoop device is: comprising two or more than two hoop ferrules; the cross section of the hoop ferrule is a rectangle or a rough rectangle, two or more than two heat dissipation grooves are disposed on one side of the hoop ferrule at intervals, or two or more than two heat dissipation grooves are disposed on each side of the two sides of the hoop ferrule at intervals.

Wherein, the width of the bottom is greater than that of the top on the cross section of the hoop ferrule.

As a further improvement, the structure of the hoop device is: comprising a hollowed-out hoop case, wherein the solid part of the hoop case is connected together, and the hollow part of the hoop case is in communication with atmosphere.

Wherein, the hollow part of the hoop case comprises one or more than one heat dissipation hole groups, each heat dissipation hole group comprising two or more than two arc-shaped long holes arranged along the circumferential direction at intervals.

As another improvement, two or more than two annular convex ribs are disposed on part of the outer peripheral surface of the braking portion adjacent to the transitional connecting portion, and an annular groove is formed between two adjacent annular convex ribs.

Upon employing the above technical solutions, the beneficial effects of the present invention are:

Because one, two or more than two preformed cracks are disposed in the wall of the braking portion, wherein each crack starts at the end or vicinity thereof of the braking portion and ends at the transitional connecting portion, heat expansion stress and tension stress of the brake drum body are released in the preformed cracks during braking, thereby reducing the probability that the brake drum body develops from longitudinal micro cracks to random multiple cracks and finally develops into fractures, which improves safety and extends service life. In addition, the hoop device tightly mounted on the outer peripheral surface of the braking portion can not only effectively restrain the radial expansion deformation, thereby improving the tensile resistance strength and fatigue resistance, but also apply a clasp force to the brake drum body, thereby avoiding the danger of burst and flying out of the brake drum body, which greatly improves service life and use safety. Moreover, the wall thickness of the braking portion corresponding to the hoop device can be effectively reduced, which not only decreases the brake weight and effectively lowers the temperature difference between the interior and exterior of the brake drum body, but also increases heat conductivity and improves the impact effect of the brake drum body by transmitting the braking tension force and heat expansion stress to the hoop device, thereby laying foundation for heat dissipation and prevention of the happening of the multiple cracks in the inner wall of the brake drum body.

The hoop device tightly mounted to the outer peripheral surface of the braking portion can not only effectively restrain the radial expansion deformation and improve the fatigue resistance, but also applies a clasp force to the brake drum body, eliminating the danger of burst and flying out of the brake drum body, which greatly improves service life and safety. Moreover, the wall thickness of the braking portion corresponding to the hoop device can be effectively reduced, which not only reduces the brake weight and effectively decreases the temperature difference between the interior and exterior of the brake drum body, but also increases heat conductivity, which lays foundation for both heat dissipation and prevention of the happening of multiple cracks in the inner wall of the brake drum body.

The annular convex ribs disposed on part of the outer peripheral surface of the braking portion not only improves the strength of the brake drum body, but also increases heat dissipation areas, and moreover, the manufacturability is excellent and the cost is low. Combining with the hoop device, it further achieves the goal of improving safety and extending service life with a more economical cost.

When the hoop device uses split-type hoop ferrules, the hoop ferrules are easy to be processed and manufactured due to their single row structure, which improves the flexibility of assembling.

When the hoop device uses hollowed-out hoop case, the hoop ferrules are easy to be assembled due to their unibody structure, which improves the assembling efficiency of the hoop case and the brake drum body.

As another improvement, a method for manufacturing the brake drum of the present invention is: the drum body is constructed by casting, and then post-processing such as crack forming and cutting, especially post-processing such as cutting of the braking portion of the drum body, can increase the uniformity of the drum body to ensure the assembling precision of the hoop ferrule. At the same time, the casting residual of the drum body after processing is low, which improves the dynamic balance of the brake drum. The post-processing approach is used to form hoop ferrule grooves and the aforementioned convex rib structures. Post-processing may be applied only to the outer peripheral surface of the drum body. Hoop ferrules are independently manufactured and processed, and then tightly mounted to the drum body after heat expansion. The method of the present invention also improves the dynamic balance of the brake drum and increases the yield of final products.

### DESCRIPTION OF DRAWINGS

FIG. 1 is the three-dimensional structure schematic diagram of Example 1 of the present invention;

FIG. 2 is the front view of FIG. 1;

FIG. 3 is the three-dimensional structure schematic diagram of the hoop case in FIG. 1;

FIG. 4 is the front view of the brake drum body in FIG. 1;

FIG. 5 is the three-dimensional structure schematic diagram of Example 2 of the present invention;

FIG. 6 is the front view structure schematic diagram of Example 3 of the present invention;

FIG. 7 is the section view structure schematic diagram of FIG. 6;

FIG. 8 is the section view structure schematic diagram of Example 4 of the present invention.

In the Drawings, 1-brake drum body; 101-mounting portion; 102-transitional connecting portion; 103-braking portion; 2-reinforcing rib; 3-hoop case; 31-annular convex rib; 32-arc-shaped long hole; 4-through-hole; 5-process groove; 6-crack; 71-first hoop ferrule; 701-annular groove; 72-second hoop ferrule.

### EMBODIMENTS

In order to clearly understand the objectives, technical solutions and advantages of the present invention, the present invention will be further described in detail in reference to the drawing and examples herein below. It should be understood that the specific examples described herein are only used to explain the present invention, but not used to limit the present invention.

### EXAMPLE 1

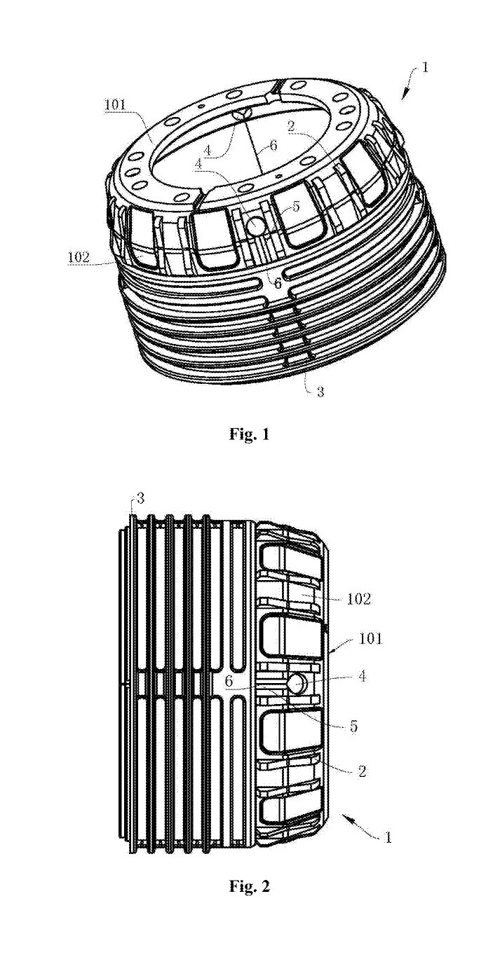

As shown altogether in FIGS. 1, 2 and 4, a brake drum, comprising: a cast molding brake drum body 1, which has a mounting portion 101 in connection with a wheel and a braking portion 103 for engaging with a brake shoe; a transitional connecting portion 102 is disposed between the mounting portion 101 and the braking portion 103; the mounting portion 101 is a flange plate structure, and a plurality of reinforcing ribs 2 are longitudinally disposed on the transitional connecting portion 102.

Four cracks 6 are evenly disposed on the wall of the braking portion 103. Each crack begins at an end of the braking portion 103 and ends at the transitional connecting portion 102. Four through-holes 4, the number of which corresponds to the cracks 6, are disposed in the transitional connecting portion 102, and each crack 6 ends at one through-hole 4. In order to form cracks, process grooves 5 need to be disposed on the brake drum body 1 during casting, the process grooves 5 are connected with the through-holes 4, and linear cracks are formed in the process grooves 5 by punch forming. The function of the cracks is to release the heat expansion stress or tension stress produced by the brake drum body 1 when braking, thereby reducing the probability that the longitudinal micro cracks of the brake drum body develops into multiple cracks and finally into fractures, which improves safety. The number of crack 6 is at least one, and if it is two, the cracks are preferably evenly distributed in the annular wall of the whole braking portion 103. The reinforcing ribs will be arranged on the two sides of cracks to improve the integral strength of the brake drum body.

As shown in FIGS. 1 and 2, a hoop device is tightly mounted to the whole outer peripheral surface of the braking portion 103. In Example 1, the hoop device is a hollowed-out hoop case 3 which is preferably made of cast iron material, and can also be made of cast steel, aluminum alloy or other materials. Generally, the hoop case 3 and the brake drum main body 1 need to be heat-assembled to ensure that the hoop case 3 does not detach from the brake drum body 1 in any conditions.

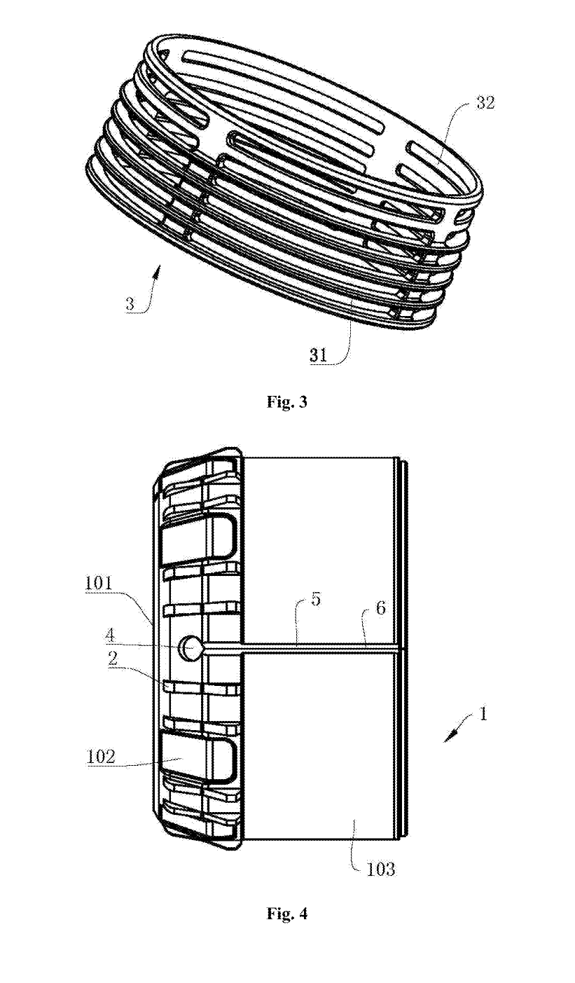

As shown in FIG. 3, the solid part of the hoop case 3 is connected together, and the hollow part of the hoop case 3 is open to atmosphere to improve the effect of heat dissipation. The hollow part of the hoop case 3 comprises a plurality of heat dissipation hole groups with at least one group required. Each heat dissipation hole group comprises a plurality of (two or more than two) arc-shaped long holes 32 arranged along the circumferential direction at intervals. In order to improve the structural strength and mechanical property of the hoop case 3, the solid part of the hoop case 3 are disposed with a plurality of (one or more than one) annular convex ribs 31 on the outer peripheral surface thereof. The annular convex ribs 31 are disposed adjacent to the heat dissipation hole groups. The hollowed-out structure is not limited to what is described above, but all structures that can both ensure strength and facilitate heat dissipation are feasible. The greatest advantage of the hollowed-out structure is that the hoop case 3 can be made into one whole entity, which can increase the assembling efficiency of the hoop case 3 and the brake drum body 1.

### EXAMPLE 2

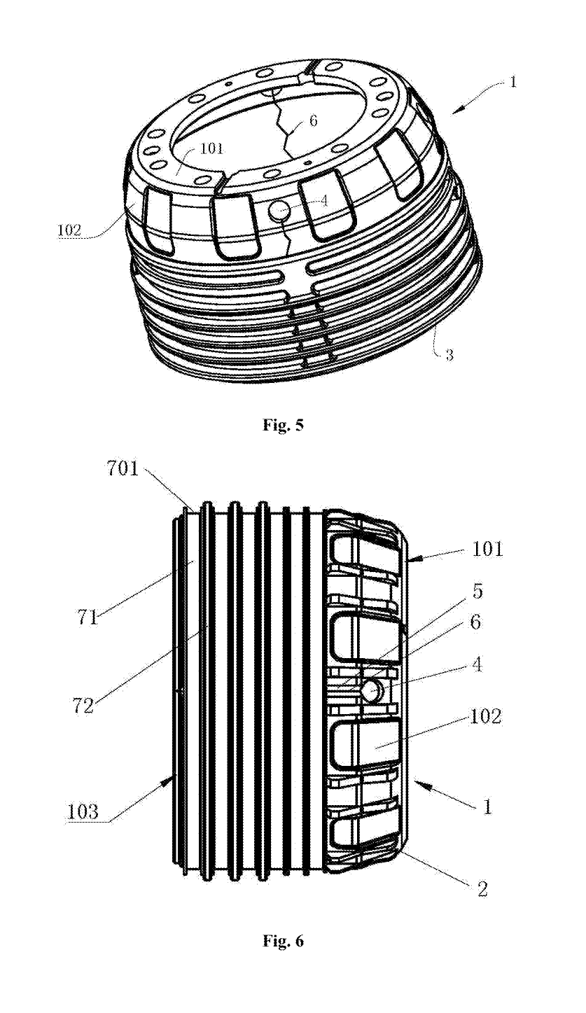

As shown in FIG. 5, the specific structure of Example 2 is basically identical with that of Example 1, while the differences are: the cracks 6 are zigzag cracks formed by wire cutting, and due to use of the wire cutting, no preformed process grooves are needed. The cracks 6 may also be wavy-shaped cracks or other forms of cracks that can be realized by skilled artisans and do not affect the normal operation of the brake drum. Reinforcing ribs 2 are also not required.

### EXAMPLE 3

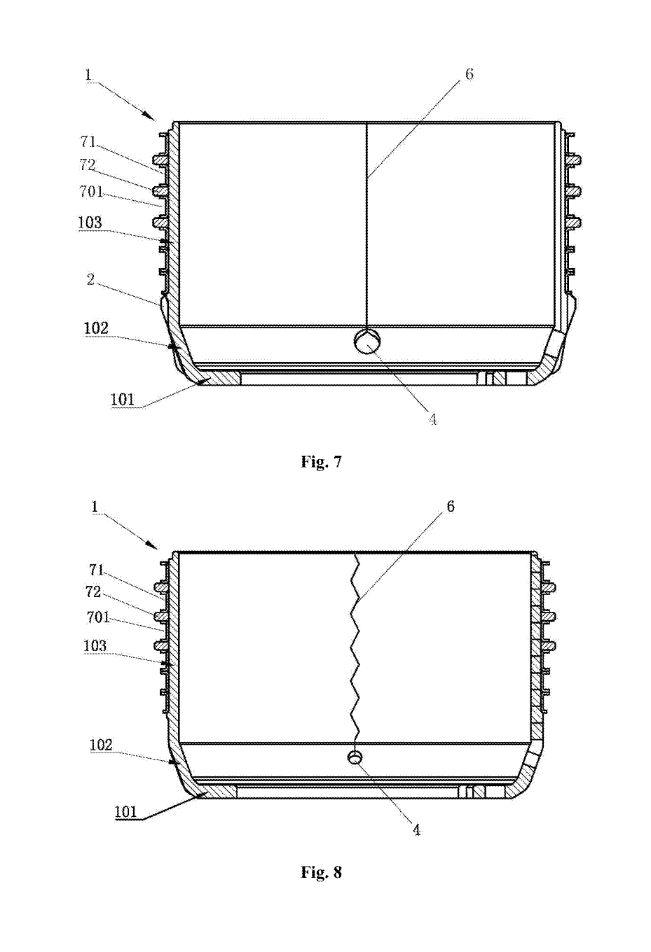

As shown in FIGS. 6 and 7, the specific structure of Example 3 is basically identical with that of Example 1, while the differences are: in Example 3, the hoop device comprises a plurality of (two or more than two) first hoop ferrules 71 arranged in the axial direction; an annular groove 701 having an extending direction identical with the first hoop ferrules is disposed on the outer circle of the first hoop ferrules 71 (that is, the cross section shape of the first hoop ferrule 71 is roughly U-shaped); the first hoop ferrule 71 adjacent to the transitional connecting portion 102 abut against the transitional connecting portion 102; second hoop ferrules 72 are disposed on the braking portion 103 away from the transitional connecting portion 102 and between two adjacent first hoop ferrules 71. As shown in these figures: three first hoop ferrules 71 are axially arranged from the abutting position with the transitional connecting portion 102, then three pairs of the second hoop ferrules 72 and the first hoop ferrules 71 are disposed at intervals; all the second hoop ferrules 72 and first hoop ferrules 71 abut against each other. The figures are only schematic, the number of the second hoop ferrules 72 and first hoop ferrules 71 and whether the second hoop ferrules 72 and first hoop ferrules 71 abut against each other or not are not limited here.

Wherein, the width of the first hoop ferrule 71 is greater than that of the second hoop ferrule 72, and the external diameter of the first hoop ferrule 71 is less than that of the second hoop ferrule 72.

Wherein, the external diameter of the end of the transitional connecting portion 102 adjacent to the braking portion 103 is greater than that of the braking portion 103, so as to facilitate the outermost first hoop ferrule 71 to abut against the transitional connecting portion 102.

Because first hoop ferrule 71 is disposed with an annular groove 701, and the width of the first hoop ferrule 71 is greater than that of the second hoop ferrule 72, the heat dissipation effect of the brake drum with such a structure is greatly improved through first hoop ferrule 71. Meanwhile, the first hoop ferrule 71 and the second hoop ferrule 72 are combined and applied to be tightly mounted to the outer peripheral surface of the braking portion, which improves the structural strength and bearing capacity of the brake drum body. The first hoop ferrule 71 and second hoop ferrule 72 with a split-type structure that are adopted in the hoop device facilitate processing and manufacturing and improves the flexibility of assembling.

### EXAMPLE 4

As shown in FIG. 8, the specific structure of Example 4 is basically identical with that of Example 3, while the differences are: in Example 4, the cracks 6 are zigzag-shaped cracks formed by wire cutting, and due to the use of wire cutting, no preformed process grooves are needed. The cracks 6 may also be wavy-shaped cracks or other forms of cracks that can both be realized by skilled artisans and do not affect the normal operation of the brake drum. Reinforcing ribs 2 are also not required.

The above descriptions are only preferred examples of the present invention, which are not used to limit the present invention. Any amendments, equivalent replacements and improvements within the spirit and principle of the present invention should be all included in the protection scope of the present invention.

### INDUSTRIAL APPLICABILITY

Because one, two or more than two cracks are disposed in the wall of the braking portion of the brake drum, wherein each crack starts at the end of the braking portion and ends at the transitional connecting portion, heat expansion stress and tension stress of the brake drum body are released in the cracks during braking, thereby reducing the probability that the brake drum body develops from longitudinal micro cracks to random multiple cracks and finally develops into fractures, which improves safety and extends service life. In addition, the hoop device tightly mounted on the outer peripheral surface of the braking portion can not only effectively restrain the radial expansion deformation, thereby improving the tensile resistance strength and fatigue resistance, but also apply a clasp force to the brake drum body, thereby avoiding the danger of burst and flying out of the brake drum body, which greatly improves service life and use safety. Moreover, the wall thickness of the braking portion corresponding to the hoop device can be effectively reduced, which not only effectively decreases the temperature difference between the interior and exterior of the brake drum body, but also increases heat conductivity and improves the impact effect of the brake drum body by transmitting the braking tension force or heat expansion stress to the hoop device, thereby laying foundation for heat dissipation and prevention of the happening of the multiple cracks in the inner wall of the brake drum body.

What is claimed:

1. A brake drum, comprising: a brake drum body having a cylindrical shape, which sequentially includes in its axial direction a mounting portion for connecting with a wheel, a braking portion for fitting with a brake shoe, and an opening end of the brake drum; a transitional connecting portion is disposed between the mounting portion and the braking portion;
wherein, one, two or more than two cracks are disposed in the wall of the braking portion, each crack starting from the vicinity of the end of the braking portion and ending at the transitional connecting portion; and a hoop device is tightly mounted to the outer peripheral surface of the braking portion.

2. The brake drum according to claim 1, wherein the hoop device comprises two or more than two hoop ferrules.

3. The brake drum according to claim 2, wherein the hoop ferrules are made of steel material.

4. The brake drum according to claim 2, wherein the cross section area of the hoop ferrule in an axial middle position of the braking portion is greater than the cross section area of the hoop ferrule on two sides of the braking portion.

5. The brake drum according to claim 4, wherein a plurality of hoop ferrule mounting grooves are disposed on the outer peripheral surface of the braking portion, and each hoop ferrule is restrainedly mounted in one hoop ferrule mounting groove.

6. The brake drum according to claim 2, wherein the cross section shape of the hoop ferrule is rectangle, T-shaped, side H-shaped, square, semicircular or U-shaped.

7. The brake drum according to claim 2, wherein the cross section shape of the hoop ferrule is unequal-height U-shaped; the outer peripheral surface of the braking portion is disposed with hoop ferrule mounting grooves, and all the hoop ferrules abut against each other sequentially and are restrainedly mounted in the hoop ferrule mounting grooves.

8. The brake drum according to claim 4, wherein the height of the hoop ferrule decreases incrementally from the axial middle position to the two sides of the braking portion.

9. The brake drum according to claim 1, wherein the hoop device comprises a plurality of first hoop ferrules arranged and disposed in the axial direction, and a second hoop ferrule disposed away from the transitional connecting portion and between two adjacent first hoop ferrules, and all the first and second hoop ferrules abut against each other; and
the width of the first hoop ferrule is greater than that of the second hoop ferrule, and the external diameter of the first hoop ferrule is less than that of the second hoop ferrule.

10. The brake drum according to claim 9, wherein the cross section shape of the first hoop ferrule is U-shaped or L-shaped or square; the cross section shape of the second hoop ferrule is square or semicircular or U-shaped.

11. The brake drum according to claim 2, wherein the cross section of the hoop ferrule is a rectangle or a rough rectangle, and two or more than two heat dissipation grooves are disposed on one side of the hoop ferrule at intervals, or two or more than two heat dissipation grooves are disposed on each side of the two sides of the hoop ferrule at intervals.

12. The brake drum according to claim 11, wherein the width of the bottom is greater than the width of the top on the cross section of the hoop ferrule.

13. The brake drum according to claim 1, wherein the hoop device comprises a plurality of hoop ferrules connected to each other at multiple sites on a bottom structure to form a hoop case which is tightly mounted onto the braking portion of the brake drum body.

14. The brake drum according to claim 13, wherein one or more than one heat dissipation hole groups are formed at the base of the hoop cases, and each heat dissipation hole group comprises two or more than two arc-shaped long holes arranged along the circumferential direction at intervals.

15. The brake drum according to claim 2, wherein the brake drum body comprises one or more than one hoop ferrules having a tooth-shaped cross section adjacent to the connecting portion.

16. The brake drum according to claim 15, wherein the radial thickness of the tooth-shaped hoop ferrule is less than that of the hoop ferrule in other parts.

17. The brake drum according to claim 10, wherein the hoop case is made of steel material, cast iron or aluminum alloy.

18. The brake drum according to claim 1, wherein two or more than two annular convex ribs are disposed on the outer peripheral surface of the brake drum body adjacent to the transitional connecting portion, and an annular groove is formed between two adjacent annular convex ribs.

19. The brake drum according to claim 1, wherein through-holes, the number of which corresponds to the number of the cracks, are disposed on the transitional connecting portion, and each crack ends at one through-hole.

20. The brake drum according to claim 19, wherein the cracks are linear or zigzag cracks.

21. A method for manufacturing the brake drum according to claim 1, wherein the drum body is constructed through casting, and then the dynamic balance of the drum body is increased by post-processing such as cutting; a hoop ferrule is independently manufactured and processed, and then tightly mounted to the drum body after heat expansion of the hoop ferrule.

22. A method for manufacturing the brake drum according to claim 20, wherein a hoop ferrule groove is formed in the braking portion of the drum body, and a convex rib and a groove structure are formed in the connecting portion of the drum body.

23. A method for manufacturing the brake drum according to claim 20, wherein the cracks are formed into linear or wavy cracks by wire cutting after the drum body is formed; or process grooves and through-holes are disposed in the drum body during the casting of the drum body, the process grooves being connected with the through-holes, and linear cracks are formed in the process grooves by punch forming after the drum body is constructed through casting.
